(19) United States
(12) Patent Application Publication
(10) Pub. No.: US 2006/0287935 A1
(43) Pub. Date: Dec. 21, 2006

(54) Methods and Systems for Providing enhanced Capital Advantaged Preferred Securities

(75) Inventors: Erin Callan, New York, NY (US); John Curran, Bronxville, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc, New York, NY (US)

(21) Appl. No.: 11/164,756

(22) Filed: Dec. 5, 2005

Related U.S. Application Data
(60) Provisional application No. 60/681,899, filed on May 16, 2005.

(51) Int. Cl. G06Q 40/00

(52) U.S. Cl. 705/35

(57) ABSTRACT

In one aspect, the invention comprises a method comprising: (a) forming a limited liability company (“ULLC”) operable to issue LLC preferred securities; (b) forming a trust operable to issue trust preferred securities and to purchase LLC preferred securities from the LLC; and (c) issuing subordinated notes with at least a 30-year maturity to the LLC. In another aspect, the invention comprises a method comprising: (a) forming a trust operable to issue trust preferred securities and to purchase LLC preferred securities; and (b) receiving over the computer network subordinated notes with a maturity of at least 30 years from a parent. In another aspect, the invention comprises a security that: (a) is tax deductible, and (b) receives equity credit above 50% from Moody's and S&P.

### CROSS-REFERENCE TO RELATED APPLICATIONS

This application claims the benefit of U.S. Provisional Application No. 60/681,899, filed May 16, 2005. The entire contents of that provisional application are incorporated herein by reference.

### BACKGROUND & SUMMARY

Two current structures available to issuers are trust preferred or perpetual preferred stock with equity enhancements (mandatory deferral). Perpetual preferred has become more attractive recently due to changes at the rating agencies.

Trust preferred securities are dated cumulative preferred securities issued out of a special purpose entity, usually in the form of a trust, in which a parent owns all of the common securities. The trust's sole asset is a deeply subordinated note issued by the parent. The subordinated note, which is senior only to the Parent's common and preferred stock, has terms that generally mirror those of the trust preferred securities.

The terms of the trust preferred securities allow dividends to be deferred for at least a 20 consecutive quarter period without creating an event of default or acceleration. After the deferral of dividends for this 20 quarter period, if the Parent fails to pay the cumulative dividend amount owed to investors, an event of default and acceleration occurs, giving investors the right to acquire the subordinated note issued by the Parent. At the same time, the Parent's obligation to pay principal and interest on the underlying junior subordinated note accelerates and the note becomes immediately due and payable.

A key advantage of trust preferred securities to the Parent is that for tax purposes the dividends paid on trust preferred securities, unlike those paid on directly issued preferred stock, are a tax deductible interest expense. The IRS ignores the trust and focuses on the interest payments on the underlying subordinated note.

Trust Preferred Securities receive limited equity credit from the rating agencies (Moody's: 0%; S&P: 40% (corporates) and 100% (financials)).

Perpetual preferred stock has no fixed maturity date and cannot be redeemed at the option of the holder. Perpetual preferred stock, with certain features, can obtain high equity credit (Moody's: 75-100%; S&P: up to 60% (corporates) and 100% (financials)) but is more expensive capital since it is not tax deductible-dividends are paid out of after tax earnings and profits.

A preferred embodiment of the present invention provides many of the advantages of the two products described above, while avoiding many of the disadvantages. The preferred embodiment provides securities (enhanced capital advantaged preferred securities (“ECAPS”) that are tax-deductible yet also receive equity credit similar to that of perpetual preferred stock. This preferably is accomplished by: (1) the LLC and the trust issuing 60-year securities to investors; (2) an optional and mandatory deferral feature is added to ensure high equity content [Alternatively, the LLC can be eliminated and the Trust will directly make a 60 yr+deeply subordinated loan to Parent]; (3) a required sale of common or preferred stock to pay distributions after 20 periods of optional deferral or immediately upon occurrence of mandatory deferral to allow preservation of existing cash for creditors, while paying distributions as required for tax purposes; (4) a parent creating an LLC and a trust contributing capital to the LLC; (5) the LLC making a deeply subordinated dated loan (30+years) back to the company; (6) at maturity of the initial loan, the LLC will likely reinvest in similar deeply subordinated loans of the parent or affiliates.

Embodiments of the present invention preferably comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

In one aspect, the invention comprises a computer based method comprising: (a) forming a limited liability company (“LLC”) operable to issue LLC preferred securities over a computer network; (b) forming a trust operable to issue trust preferred securities over the computer network and to purchase LLC preferred securities from the LLC over the computer network; and (c) electronically issuing over the computer network subordinated notes with at least a 30-year maturity to the LLC.

In another aspect, the invention comprises a computer based method comprising: (a) forming a trust operable to issue trust preferred securities over a computer network and to purchase LLC preferred securities over the computer network; and (b) electronically receiving over the computer network subordinated notes with a maturity of at least 30 years from a parent.

In another aspect, the invention comprises a method comprising: (a) forming a limited liability company (“LLC”) operable to issue LLC preferred securities; (b) forming a trust operable to issue trust preferred securities and to purchase LLC preferred securities from the LLC; and (c) issuing subordinated notes to the LLC.

In various embodiments: (1) the LLC is operable to invest proceeds from redemption of the subordinated notes into long-dated subordinated loans; (2) the subordinated notes have a maturity of at least 30 years; (3) the trust preferred securities are 60-year dated preferred securities; (4) the LLC preferred securities are 60-year dated preferred securities; (5) the LLC is operable to invest proceeds from redemption of the subordinated notes into short term, high quality third party assets; (6) the subordinated notes are 20% loaned to affiliates; (7) the method further comprises guaranteeing the subordinated notes; (8) the method further comprises contributing up to 5% of total capital for a managing member interest in the LLC; and (9) the LLC and the trust are covered by a support agreement that ensures that each will have enough assets to pay its obligations.

In another aspect, the invention comprises a method comprising: (a) forming a trust operable to issue trust preferred securities and to purchase LLC preferred securities; and (b) receiving subordinated notes with a maturity of at least 30 years from a parent in exchange for a loan to the parent.

In various embodiment: (1) the subordinated notes have a deferral period of 10-12 years; (2) after a predetermined period of optional deferral, the parent is obligated to sell common or preferred stock in order to fund distribution payments; (3) the predetermined period is five years; (4) upon mandatory deferral, the parent is obligated to issue common or preferred stock in order to fund distribution payments; (5) after 10-12 years of deferral, holders of the subordinated notes have a right to accelerate the loan and the notes become immediately due and payable.

In another aspect, the invention comprises a security that: (a) is tax deductible, and (b) receives equity credit above 50% from Moody's and S&P.

In various embodiments: (1) the equity credit is similar to that of perpetual preferred stock; (2) the security is a preferred security issued by a trust, wherein the trust is operable to purchase LLC preferred securities from an LLC, and wherein the LLC is operable to purchase subordinated notes from a parent with funds received from the trust in exchange for the LLC preferred securities; (3) the LLC is operable to invest proceeds from redemption of the subordinated notes into long-dated subordinated loans; (4) the LLC preferred securities are 60-year dated preferred securities; (5) the security is a 60-year dated preferred security; (6) the LLC is operable to invest proceeds from redemption of the subordinated notes into short term, high quality third party assets; (7) the subordinated notes are 20% loaned to affiliates; (8) the subordinated notes are guaranteed by the parent; and (9) the LLC and the trust are covered by a support agreement that ensures that each will have enough assets to pay its obligations.

### BRIEF DESCRIPTION OF THE DRAWINGS

FIG. 1 illustrates a preferred ECAPS structure.

FIG. 2 depicts preferred flow for cash and securities.

FIG. 3 depicts an alternate embodiment, with a foreign parent.

### DETAILED DESCRIPTION OF PREFERRED EMBODIMENTS

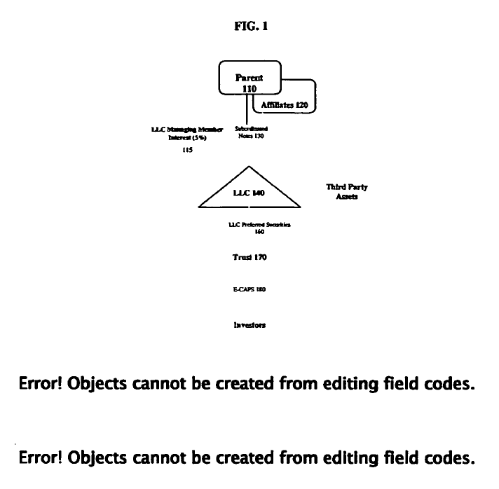

In one preferred embodiment, referring to FIG. 1, Parent 110 forms Limited Liability Company (LLC) 140 and contributes minimal proceeds 115 equal to 0-5% of total capital (including LLC preferred) for the managing member interest. Parent also causes a Delaware Trust 170 to be formed. Parent owns all of the common securities of the LLC and the Trust.

Trust 170 issues 60-year preferred securities with capital replacement language—ECAPS 180—to investors and purchases mirror LLC preferred securities 160.

LLC will on-loan to Parent 110 the proceeds from the ECAPS offering in the form of subordinated notes 130 with a 30-year maturity. That is, the Parent issues the notes to the LLC and pays interest on the notes to the LLC. Interest payments on the subordinated notes 130 will fund distribution payments for ECAPS 180. The Parent preferably guarantees the trust preferred securities and, of course, the subordinated notes. These guarantees will be recognized by those skilled in the art as required under the Securities Act of 1940.

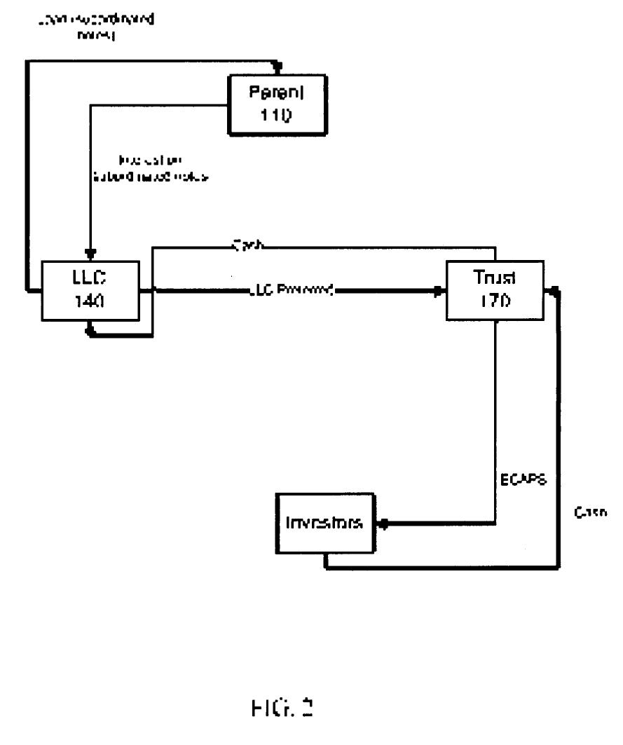

FIG. 2 depicts flow of cash and securities between the various entities.

At initial maturity of subordinated notes 130 (in year 30), LLC 140 can invest the proceeds from the redemption of subordinated notes 130 into: (a) long-dated subordinated loans on similar terms to Parent 110 or to other Affiliates 120; Affiliate loans may be guaranteed by Parent.

These ECAPS preferably have “enhanced equity credit” features: (1) long-dated maturity—60 years; (2) cumulative distributions with a “mandatory deferral” of distributions upon breach of trigger; and (3) capital replacement “intent” language. “Tax deductible features” comprise: (1) ultimately on-loan to Parent of dated subordinated note; (2) the holders of the ECAPS right to liquidate the LLC and claim the subordinated note after deferral of distributions for 7 years, and ultimately accelerate the notes after a maximum of 12 years aggregate deferral; (3) creating a wholly-owned LLC subsidiary that allows reinvestment in dated subordinated notes; (4) parent issues 30-year subordinated notes to LLC in exchange for preferred proceeds; and (5) required investment of LLC assets in subordinated or third-party assets at maturity.

ECAPS are expected to achieve the same rating agency benefit as directly issued high equity content preferred stock, while achieving better cost efficiency due to tax-deductible distributions.

ECAPS Compared to Trust Preferred

Issuer

The issuer for trust preferred is typically a Delaware business trust owned by a parent. The issuer for ECAPS is preferably a Delaware business owned by a parent that invests in LLC preferred.

Taxation

The trust for trust preferred is treated as a grantor trust, and thus ignored for tax purposes. The same applies to the ECAPS trust; the LLC is treated as a partnership for tax purposes.

Accounting

A trust-preferred trust is deconsolidated under FIN 46, and the junior subordinated debt appears as equity on the balance sheet. For ECAPS, both the LLC and the trust will be deconsolidated under FIN 46, and the junior subordinated debt will appear as equity on the balance sheet.

Maturity

Maturity for trust preferred is 30-49 years; for ECAPS, 60 years.

Assets of issuer

For trust preferred, assets are the junior subordinated debt of parent 110. There is no reinvestment. For ECAPS, assets are the junior subordinated debt of the parent 110 and affiliates 120, and a small percentage (1-5%) of assets may be invested in eligible third party assets 150. At maturity of the debt, LLC 140 must reinvest in similar debt of parent 110 and affiliates 120.

Payments

For trust preferred, payments are cumulative, and deferrable for 5 years at issuer's option. All deferred payments must be repaid at the end of the 5 years. For ECAPS, payments are deferrable for 5 years at issuer's option, but deferred payments do not need to be repaid until the ECAPS are redeemed. Moreover, payments are mandatorily deferrable if certain financial metrics are breached: upon a breach of “mandatory deferral trigger” or optional deferral for 5 years, the parent 110 must use commercially reasonable efforts to issue preferred or common stock to fund distributions.

Subordination

Trust preferred is subordinated to senior and subordinated debt holders. ECAPS are subordinated to senior, subordinated debt, trust preferred.

ECAPS Equity Content

Feature 1: No or Long-dated Maturity. ECAPS have 60-year maturity with a capital replacement feature. This results in a Moody's equity content scoring of “moderate.”

Feature 2: No Ongoing Payments. ECAPS have optional deferral of subordinated notes interest up to 5 years, and a mandatory deferral of preferred dividends upon breach of a trigger. In the event of a mandatory deferral or optional deferral of more than 5 years (20 quarters) the Parent must use commercially reasonable efforts to issue common or preferred stock to fund distributions due on ECAPS. This results in a Moody's equity content scoring of “strong.”

Feature 3: Loss Absorption. ECAPS are junior to all creditors and thus provide a loss-absorbing cushion. This results in a Moody's equity content scoring of “moderate/strong.”

Based on the above scoring, ECAPS will receive the same treatment as Basket D Preferred Stock.

Tax Treatment

ECAPS will be treated as partnership interests in LLC 140. Parent 110 and its operating subsidiaries will be entitled to deductions on interest payments made on the Subordinated Notes held by LLC 140. ECAPS holders will be allocated interest income equal to the distribution rate on LLC Preferred Securities 160.

Accounting

LLC 140 will be deconsolidated under FIN 46. On a consolidated basis, parent 110 issues 30-year subordinated debt.

Corporate

LLC 140 and trust 170 will be need to added to parent 110's shelf in order to do a registered transaction. Alternatively, ECAPS can be sold as 144A.

Example term sheets (“indicative terms and conditions”) for ECAPS are provided below in the Appendices.

In an alternate embodiment, and referring again to FIG. 1, Trust 170 issues perpetual preferred securities with capital replacement language—ECAPS 180—to investors and purchases mirror LLC preferred securities 160.

LLC will on-loan to Parent 110 and at least 2 Affiliates 120 (e.g., 80% to Parent 110, 20% to Affiliates 120) the proceeds from the ECAPS offering in the form of subordinated notes 130 with a 30-year maturity. Affiliate loans may be guaranteed by Parent 110. Interest payments on the subordinated notes 130 will fund distribution payments for ECAPS 180.

At initial maturity of subordinated notes 130 (in year 30), LLC 140 can invest the proceeds from the redemption of subordinated notes 130 into: (a) long-dated subordinated loans on similar terms to Parent 110 or to other Affiliates 120; or (b) short-term, high quality third party assets 150.

These ECAPS preferably have “enhanced preferred stock” features: (1) long-dated; (2) cumulative dividends with mandatory deferral of distributions upon breach of trigger; and (3) capital replacement “intent” language. “Tax deductible features” comprise: (1) wholly-owned LLC subsidiary issues preferred securities; (2) parent issues 30-year subordinated notes to LLC in exchange for preferred proceeds; (3) 5% of LLC assets must be invested in third-party assets; and (4) required investment of LLC assets in subordinated or third-party assets at maturity.

In another embodiment, the company forms a Trust and on-loans proceeds to the Parent in the form of a 60-year subordinated loan. The Subordinated Note will have same level of subordination as the note in the LLC structure.

In addition, the Subordinated note will have deferral for 10 to 12 years. After 5 years of optional deferral, the Parent is required to sell common or preferred stock to fund distribution payments. Upon mandatory deferral, the Parent is immediately required to issue common or preferred stock to fund distribution payments. After 10 to 12 years of deferral, the holders of the Note have the right to accelerate the loan and the note becomes immediately due and payable.

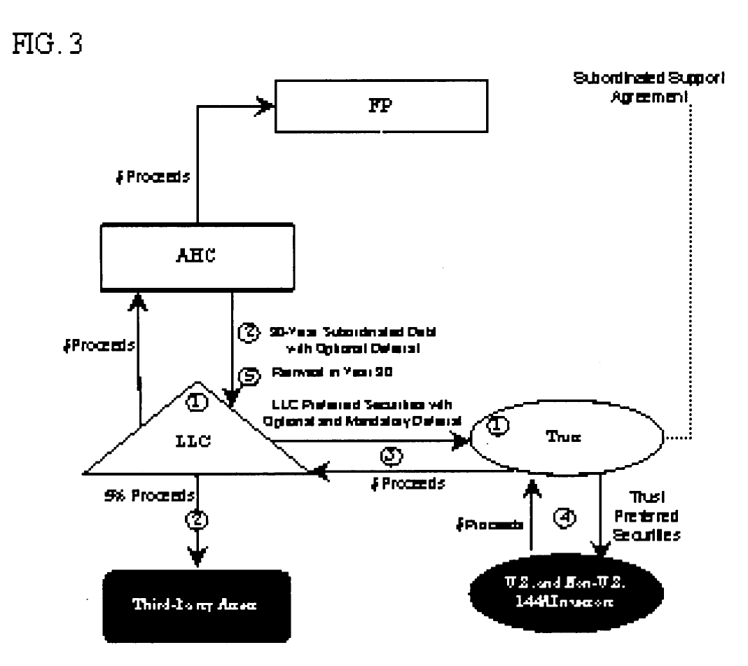

In another embodiment, the Parent may be a non-U.S. company. In that case, a more complicated arrangement may be used to obtain the tax benefits of ECAPS. For example, as depicted in FIG. 3, the Foreign Parent FP may own an American Holding Company AHC. Also formed are an LLC and a Trust.

(1) AHC Organizes LLC and Trust

Preferably, the AHC organizes LLC and in exchange for a Managing Member Interest. The AHC also organizes Trust.

(2) AHC Issues Subordinated Notes to LLC

The LLC invests in 30-year subordinated debt of AHC with a 5-year optional deferral provision. The LLC also invests 1-5% of the proceeds in high quality, short-term third party assets (e.g., A-1/P-1 CP paper).

(3) LLC Issues Preferred Securities to Trust

The Trust invests in 60-year preferred securities of the LLC with an optional deferral provision and mandatory deferral trigger event (“MDTE”). If the MDTE is breached by FP, distributions on the LLC preferred securities may only be paid from amounts received as a capital contribution from FP, the proceeds of which are raised from a sale of FP common stock. During a MDTE, payments will either be made or accrue on the AHC subordinated debt. Payments will accrue and not be made if AHC elects to utilize the optional deferral provision on the underlying subordinated debt. If payments are missed on the LLC preferred securities for a period exceeding 7 years, the LLC may be dissolved and the Trust will directly own each underlying AHC subordinated debt. If the 5-year deferral option on the subordinated debt has not been previously utilized, the 5 years of deferral is still available after liquidation of the LLC.

(4) Trust Issues Trust Preferred Securities to U.S. and Non-U.S. 144A Investors

The Trust will benefit from a subordinated Support Agreement from FP. Terms of the trust preferred securities may comprise: (a) redeemable in Year 5 (Series I) or Year 10 (Series II); and (b) redemption is subject to capital replacement intent language.

(5) Reinvestment of Subordinated Notes at Maturity

At maturity of the initial AHC subordinated debt investment in Year 30, the LLC may reinvest the proceeds at an arms-length rate in two new 30-year subordinated debts of any qualifying affiliate except for AHC. Following a reinvestment of subordinated debt of an affiliate, the affiliate debt will be rated at a minimum equal to the ratings of the ECAPS immediately prior. If reinvestment occurs in Year 30, any incremental return from a rate increase (above the stated rate) will be paid 50% to the investors of LLC preferred securities and 50% to AHC as the Managing Member.

More details regarding a preferred structure and method of this embodiment may be found in Appendix B.

Thus, in contrast to the previously described embodiments, in this embodiment the borrower on the subordinated notes is not the foreign parent (FP), but instead the U.S. subsidiary (AHC). AHC preferably also is the owner of the common securities of the Trust and the LLC. This structure allows AHC to obtain the same tax benefits as Parent in the other embodiments. However, FP is the entity on which investors rely on the credit of the group. Consequently, FP is subject to a Support Agreement (see Appendix B) that obligates FP to ensure that the Trust and the LLC have sufficient assets to meet their obligations.

What is claimed is:

1. A computer based method comprising:
forming a limited liability company (“LLC”) operable to issue LLC preferred securities over a computer network.

2. Forming a trust operable to issue trust preferred securities over said computer network and to purchase LLC preferred securities from said LLC over said computer network; and
electronically issuing over said computer network subordinated notes with at least a 30-year maturity to said LLC.

3. A computer based method comprising:
forming a trust operable to issue trust preferred securities over a computer network and to purchase LLC preferred securities over said computer network; and
electronically receiving over said computer network subordinated notes with a maturity of at least 30 years from a parent.

4. A method comprising:
forming a limited liability company (“LLC”) operable to issue LLC preferred securities;
forming a trust operable to issue trust preferred securities and to purchase LLC preferred securities from said LLC; and
issuing subordinated notes to said LLC.

5. A method as in claim 4, wherein said LLC is operable to invest proceeds from redemption of said subordinated notes into long-dated subordinated loans.

6. A method as in claim 4, wherein said subordinated notes have a maturity of at least 30 years.

7. A method as in claim 4, wherein said trust preferred securities are 60-year dated preferred securities.

8. A method as in claim 4, wherein said LLC preferred securities are 60-year dated preferred securities.

9. A method as in claim 4, wherein said LLC is operable to invest proceeds from redemption of said subordinated notes into short term, high quality third party assets.

10. A method as in claim 4, wherein said subordinated notes are 20% loaned to affiliates.

11. A method as in claim 4, further comprising guaranteeing said subordinated notes.

12. A method as in claim 4, further comprising contributing up to 5% of total capital for a managing member interest in said LLC.

13. A method as in claim 4, wherein said LLC and said trust are covered by a support agreement that ensures that each will have enough assets to pay its obligations.

14. A method comprising:
forming a trust operable to issue trust preferred securities and to purchase LLC preferred securities; and
receiving subordinated notes with a maturity of at least 30 years from a parent in exchange for a loan to said parent

15. A method as in claim 14, wherein said subordinated notes have a deferral period of 10-12 years.

16. A method as in claim 15 wherein, after a predetermined period of optional deferral, said parent is obligated to sell common or preferred stock in order to fund distribution payments.

17. A method as in claim 16, wherein said predetermined period is five years.

18. A method as in claim 15 wherein, upon mandatory deferral, said parent is obligated to issue common or preferred stock in-order to fund distribution payments.

19. A method as in claim 15 wherein, after 10-12 years of deferral, holders of said subordinated notes have a right to accelerate said loan and said notes become immediately due and payable.

20. A security that: (a) is tax deductible, and (b) receives equity credit above 50% from Moody's and S&P.

21. A security as in claim 20, wherein said equity credit is similar to that of perpetual preferred stock.

22. A security as in claim 20, wherein said security is a preferred security issued by a trust,
wherein said trust is operable to purchase LLC preferred securities from an LLC, and
wherein said LLC is operable to purchase subordinated notes from a parent with funds received from said trust in exchange for said LLC preferred securities.

23. A security as in claim 22, wherein said LLC is operable to invest proceeds from redemption of said subordinated notes into long-dated subordinated loans.

24. A security as in claim 22, wherein said LLC preferred securities are 60-year dated preferred securities.

25. A security as in claim 22, wherein said security is a 60-year dated preferred security.

26. A security as in claim 22, wherein said LLC is operable to invest proceeds from redemption of said subordinated notes into short term, high quality third party assets.

27. A security as in claim 22, wherein said subordinated notes are 20% loaned to affiliates.

28. A security as in claim 22, wherein said subordinated notes are guaranteed by said parent.

29. A security as in claim 22, wherein said LLC and said trust are covered by a support agreement that ensures that each will have enough assets to pay its obligations.
